(19) United States
(12) Patent Application Publication
(10) Pub. No.: US 2019/0039636 A1
(43) Pub. Date: Feb. 7, 2019

(54) COLLAPSIBLE CUP HOLDER SYSTEM

(71) Applicant: Walmart Apollo, LLC, Bentonville, AR (US)

(72) Inventors: Yurgis Mauro Bacallao, Centerton, AR (US); Michael Dean Atchley, Springdale, AR (US)

(21) Appl. No.: 16/037,078

(22) Filed: Jul. 17, 2018

Related U.S. Application Data
(60) Provisional application No. 62/541,895, filed on Aug. 7, 2017.

(51) Int. Cl. B62B 3/14; B60N 3/10

(52) U.S. Cl. CPC B62B 3/1472; B62B 2202/023; B60N 3/102

(57) ABSTRACT

Provided is a collapsible cup holder system for a shopping cart. The system includes a seat member having an opening wherein the seat member is a seat portion of a collapsible child seat system of the shopping cart. The system may also include a collapsible cup holder operatively coupled to the seat member. The collapsible cup holder may include a rigid cup opening member coupled to the seat member, wherein the cup opening member is aligned with the opening of the seat member, a rigid base portion formed of a rigid ring member with rigid base support members coupled to the rigid ring member, wherein the rigid base support members form a cross within an opening of the rigid ring member, and a plurality of support members, wherein the plurality of support members are rotatably coupled to the cup opening member and rotatably coupled to the base portion.

### CROSS REFERENCE TO RELATED APPLICATION

This invention claims priority to U.S. provisional patent application Ser. No. 62/541,895, file Aug. 7, 2017, and entitled “Collapsible Cup Holder System”, which is incorporated entirely herein by reference.

### FIELD OF THE INVENTION

The invention relates generally to cup holder, and more specifically, to a collapsible cup holder system for a shopping cart that is collapsible with a child seat system of the shopping cart.

### BACKGROUND

Customers are more consistently having beverages that they carry during shopping within a store. Shopping carts exist with cup holders that are typically always available and are in a fixed position with the cart. The existing cup holder systems are also lacking in the ability to retrofit existing carts with the cup holder system and further lack the ability to retrofit existing carts with a cup holder system that is foldable.

### BRIEF SUMMARY

In one aspect, provided is a collapsible cup holder system for retro fitting to a shopping cart, the system comprising: a seat member having an opening, wherein the seat member is coupled to the shopping cart in place of a seat portion of a collapsible child seat system of the shopping cart; a collapsible cup holder operatively coupled to the seat member, wherein the collapsible cup holder includes: a cup opening member coupled to the seat member, wherein the cup opening member is aligned with the opening of the seat member; a base portion; and a plurality of support members, wherein the plurality of support members are coupled between the cup opening member and the base portion.

In another aspect, provided is a collapsible cup holder system for a shopping cart, the system comprising: a seat member having an opening wherein the seat member is a seat portion of a collapsible child seat system of the shopping cart; and a collapsible cup holder operatively coupled to the seat member, wherein the collapsible cup holder includes: a rigid cup opening member coupled to the seat member, wherein the cup opening member is aligned with the opening of the seat member; a rigid base portion formed of a rigid ring member with rigid base support members coupled to the rigid ring member, wherein the rigid base support members form a cross within an opening of the rigid ring member; and a plurality of support members, wherein the plurality of support members are rotatably coupled to the cup opening member and rotatably coupled to the base portion.

In another aspect, provided is a method of using a collapsible cup holder system for a shopping cart, the system comprising: moving a foldable child seat system of a shopping cart from a closed position to an open position; rotating a collapsible cup holder system from a closed position to an open position in response to moving the foldable child seat system from the closed position to the open position, wherein a cup opening member and a base portion of the collapsible cup holder system are substantially horizontal and parallel to each other in the open position; and supporting a cup with the base portion while the cup extends through the cup opening member of the collapsible cup holder.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a perspective view of a collapsible cup holder system coupled to a shopping cart in an opened position, in accordance with some embodiments.

FIG. 2 is a perspective view of a collapsible cup holder system in an open position, in accordance with some embodiments.

FIG. 3 is a side view of a collapsible cup holder system coupled to a shopping cart in a closed position, in accordance with some embodiments.

FIG. 4 is a flow diagram illustrating a method us using a collapsible cup holder system, in accordance with some embodiments.

### DETAILED DESCRIPTION

Many store customers prefer to shop while having a beverage during the shopping experience. These customers generally bring their own drinks or further bring drinks for their kids that are shopping with them. These drinks are often balanced within the cart, either in the main cart portion or by unfolding the child seat and balancing the drink on the child seat of the shopping cart.

The present inventive concepts combine the benefits of utilizing a shopping cart during shopping while also providing the ability to fold the cup holder system to avoid interference by the cup holder when the child seat is in a closed position. The cup holder system in accordance with some embodiments permits a customer to open or unfold the child seat system of a shopping cart to a useable position and automatically deploy the cup holder and then collapse the cup holder to a stored position in response to folding or closing the child seat system of the shopping cart to a stored position.

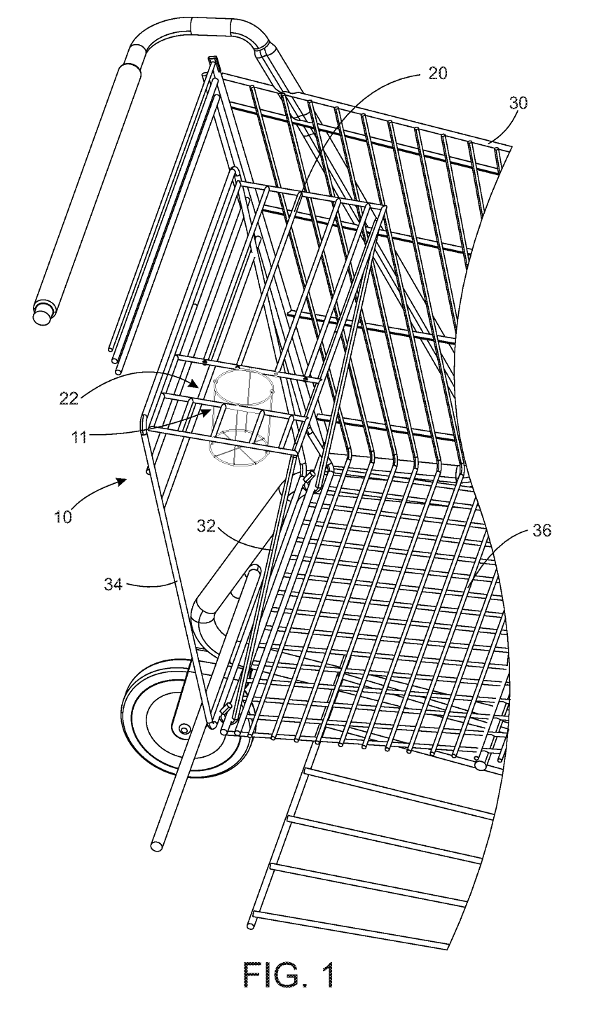

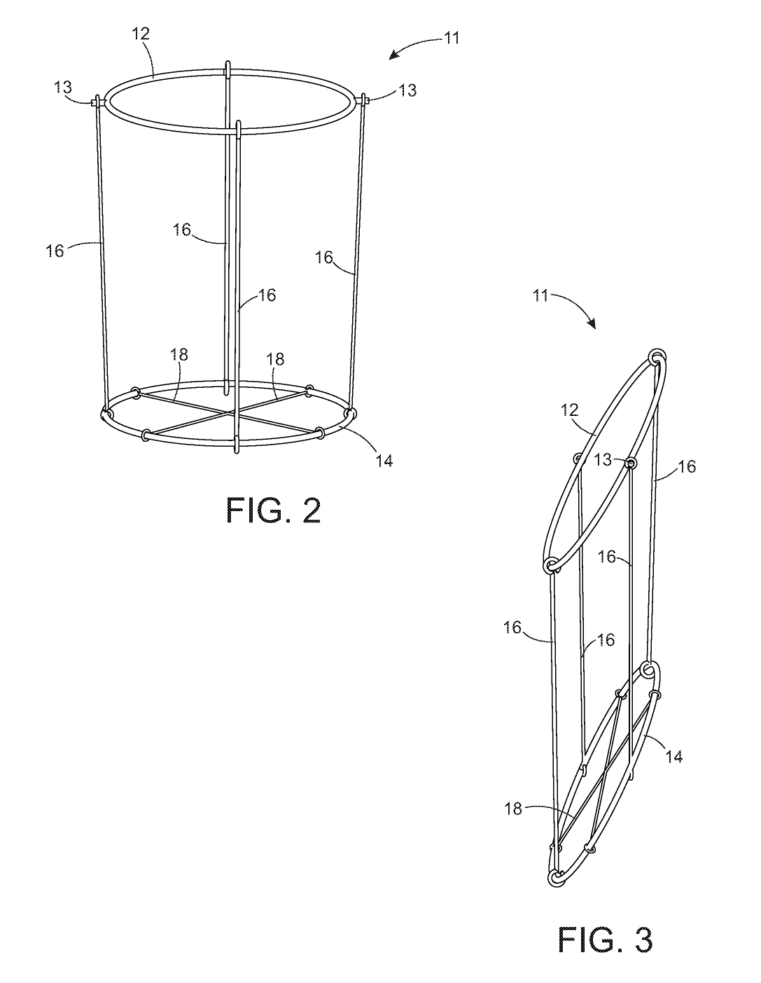

Referring to the drawings, FIG. 1 is a perspective view of a collapsible cup holder system 10, FIG. 2 is a side view of a collapsible cup holder system 10 in an opened position and FIG. 3 is a side view of a collapsible cup holder system 10 in a closed position.

The collapsible cup holder system 10 may include a collapsible cup holder 11 and a seat member 20. The seat member 20 is coupled to a shopping cart 30 in place of a seat portion of a collapsible child seat system of the shopping cart 30, wherein the seat member 20 supports a child when in an opened position. For example, the seat member 20 may be coupled between a vertical rear cart member 34 and a moveable child seat support member 32. The moveable child seat support member 32 may be pivotally coupled to the vertical rear cart member 34. The seat member 20 may be pivotally and slidingly coupled between the moveable child seat support member 32 and the vertical cart member 34, wherein rotation of the moveable child seat support member 32 away from the vertical rear cart member 34 moves the seat member 20 to an open position, wherein the seat member 20 defines a plane that is parallel to a bottom member 36 of the cart 30 in the open position, and wherein rotation of the moveable child seat support member 32 toward the vertical rear cart member 34 moves the seat member 20 to a closed position, wherein the seat member 20 defines a plane that is substantially transverse to the bottom member 36 of the cart 30 in the closed position.

The seat member 20 may include an opening 22 wherein the collapsible cup holder 11 operatively coupled to the seat member 20 at the opening 22. The collapsible cup holder 11 may include a cup opening member 12 coupled to the seat member 20, wherein the cup opening member 12 is aligned with the opening 22 of the seat member 20. In other words, the cup opening member 12 is coupled within the opening 22 wherein the cup opening member 12 is accessible through the opening 22 of the seat member 20. The cup opening member 12 may include supports 13 that couple the cup opening member 12 to the seat member 20. The supports 13 may couple cup opening member 12 in a fixed position with the seat member 20 wherein the cup opening member 12 is coplanar with the seat member 20.

The collapsible cup holder 11 may further include a base portion 14 and a plurality of support members 16, wherein the plurality of support members 16 are coupled between the cup opening member 12 and the base portion 14. The plurality of support members 16 may be rotatably coupled to the cup opening member 12 and rotatably coupled to the base portion 14, such that the plurality of supports 12 are maintained in substantially vertical positions when the collapsible cup holder 11 is in a closed position and in an opened position. Movement of the collapsible cup holder 11 between the closed position and the opened position comprises rotating the cup opening member 12 and the base portion 14 with respect to the plurality of support members 16 in response to rotation of the seat member 20 between the opened position and closed position respectively, wherein in the opened position the cup opening member 12 and the base portion 14 are substantially horizontal or parallel with a bottom member 36 of the cart 30 and in the closed position the cup opening member 12 and the base portion 14 are substantially vertical or transverse to the bottom member 36 of the shopping cart 30.

In some embodiments, the collapsible cup holder 11 may be round in shape. The cup opening member 12 may be a rigid ring. The base portion 14 may a rigid base portion formed of a rigid ring member 14 with rigid base support members 18 coupled to the rigid ring member 14. The rigid base support members 18 may form a cross within an opening of the rigid ring member 14. Further, in embodiments the rigid base support members 18 may be a unitary piece to provide a flat surface to support a cup on the base portion 14. In at least this way, the base portion 14 supports a cup inserted within the collapsible cup holder 11.

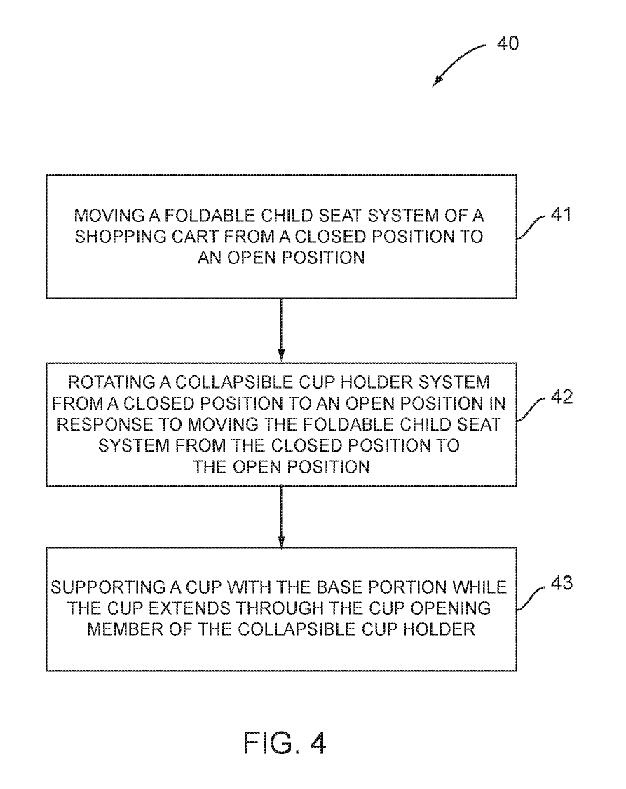

Referring to the drawings again, FIG. 4 depicts a method 40 of using a collapsible cup holder system for a shopping cart. The method 40 includes moving a foldable child seat system of a shopping cart from a closed position to an open position (Step 41); rotating a collapsible cup holder system from a closed position to an open position in response to moving the foldable child seat system from the closed position to the open position (Step 42), wherein a cup opening member and a base portion of the collapsible cup holder system are substantially horizontal and parallel to each other in the open position; and supporting a cup with the base portion while the cup extends through the cup opening member of the collapsible cup holder (step 43).

The method 40 may further comprise a step of removing the cup from the collapsible cup holder. The method 40 may then include moving the foldable child seat system of the shopping cart from the opened position to the closed position. Further still, the method 40 may include rotating the collapsible cup holder system from the open position to the closed position in response to moving the foldable child seat system from the open position to the closed position, wherein a cup opening member and a base portion of the collapsible cup holder system are substantially vertical and parallel to each other in the closed position.

While the invention has been shown and described with reference to specific preferred embodiments, it should be understood by those skilled in the art that various changes in form and detail may be made therein without departing from the spirit and scope of the invention as defined by the following claims.

What is claimed is:

1. A collapsible cup holder system for retro fitting to a shopping cart, the system comprising:
a seat member having an opening, wherein the seat member is coupled to the shopping cart in place of a seat portion of a collapsible child seat system of the shopping cart;
a collapsible cup holder operatively coupled to the seat member, wherein the collapsible cup holder includes:
a cup opening member coupled to the seat member, wherein the cup opening member is aligned with the opening of the seat member;
a base portion; and
a plurality of support members, wherein the plurality of support members are coupled between the cup opening member and the base portion.

2. The system of claim 1, wherein the collapsible cup holder is round in shape.

3. The system of claim 1, wherein seat member supports a child when in an open position.

4. The system of claim 1, wherein the collapsible cup holder collapses in response to moving the collapsible child seat portion to a closed position.

5. The system of claim 1, wherein the plurality of supports are maintained in substantially vertical positions in a closed position and in an opened position.

6. The system of claim 5, wherein the cup opening member is a rigid ring.

7. The system of claim 6, wherein the base portion is a rigid member.

8. The system of claim 7, wherein movement between the closed position and the opened position comprises rotating the cup opening member and the base portion with respect to the plurality of support members, wherein in the open position the cup opening member and the base portion are substantially horizontal and in the closed position the cup opening member and the base portion are substantially vertical.

9. A collapsible cup holder system for a shopping cart, the system comprising:
a seat member having an opening wherein the seat member is a seat portion of a collapsible child seat system of the shopping cart; and
a collapsible cup holder operatively coupled to the seat member, wherein the collapsible cup holder includes:
a rigid cup opening member coupled to the seat member, wherein the cup opening member is aligned with the opening of the seat member;
a rigid base portion formed of a rigid ring member with rigid base support members coupled to the rigid ring member, wherein the rigid base support members form a cross within an opening of the rigid ring member; and
a plurality of support members, wherein the plurality of support members are rotatably coupled to the cup opening member and rotatably coupled to the base portion.

10. The system of claim 9, wherein the collapsible cup holder is round in shape.

11. The system of claim 9, wherein seat member supports a child when in an open position.

12. The system of claim 9, wherein the collapsible cup holder collapses in response to moving the collapsible child seat portion to a closed position.

13. The system of claim 9, wherein the plurality of supports are maintained in substantially vertical positions in a closed position and in an opened position.

14. The system of claim 13, wherein the cup opening member is a rigid ring.

15. The system of claim 14, wherein the base portion is a rigid member.

16. The system of claim 15, wherein movement between the closed position and the opened position comprises rotating the cup opening member and the base portion with respect to the plurality of support members, wherein in the open position the cup opening member and the base portion are substantially horizontal and in the closed position the cup opening member and the base portion are substantially vertical.

17. A method of using a collapsible cup holder system for a shopping cart, the system comprising:
moving a foldable child seat system of a shopping cart from a closed position to an open position;
rotating a collapsible cup holder system from a closed position to an open position in response to moving the foldable child seat system from the closed position to the open position, wherein a cup opening member and a base portion of the collapsible cup holder system are substantially horizontal and parallel to each other in the open position; and
supporting a cup with the base portion while the cup extends through the cup opening member of the collapsible cup holder.

18. The method of claim 17, further comprising removing the cup from the collapsible cup holder.

19. The method of claim 18, further comprising moving the foldable child seat system of the shopping cart from the open position to the closed position.

20. The method of claim 19, further comprising rotating the collapsible cup holder system from the open position to the closed position in response to moving the foldable child seat system from the open position to the closed position, wherein a cup opening member and a base portion of the collapsible cup holder system are substantially vertical and parallel to each other in the closed position.
